(19) United States
(12) Patent Application Publication
(10) Pub. No.: US 2016/0210482 A1
(43) Pub. Date: Jul. 21, 2016

(54) Method and system for identification of smart devices

(71) Applicants: Leon Shell, JR., Marietta, GA (US); Matthew Pinkston, Douglasville, GA (US)

(72) Inventors: Leon Shell, JR., Marietta, GA (US); Matthew Pinkston, Douglasville, GA (US)

(21) Appl. No.: 14/602,273

(22) Filed: Jan. 21, 2015

(51) Int. Cl. G06K 7/10

(52) U.S. Cl. CPC G06K 7/10366

(57) ABSTRACT

An improved method and system for identification of smart devices is described.

### FIELD OF THE INVENTION

The invention relates generally to methods and systems for identification of devices and more particularly to identification tags which are attached to devices and which communicate with a portable tag reader upon activation.

### BACKGROUND OF THE INVENTION

Wireless systems exist in which portable devices are attached to items to be monitored and stationary devices transmit and receive signals from such devices. Wireless systems also exist in which the items attached to the portable devices transmit and receive signals to stationary devices. However, with all of these systems, battery life of the portable device is always an issue. Some of these systems attempt to mitigate the power issue by having the attached item transmit at intervals or have the stationary devices transmit at intervals. A problem with these systems is that it still uses unnecessary battery power. Additionally, since there can be more than one device transmitting at a given time, processing power must be employed to differentiate between the different devices.

### BRIEF SUMMARY OF THE INVENTION

Many advantages of the invention will be determined and are attained by the invention, which in a broadest sense provides methods and systems for identification of devices.

One or more embodiments of the invention provide a method for identifying a device and information related to the device. The method includes associating a tag with the device. The tag has an identifier. The tag is maintained in a dormant state when not in use. The method also includes associating information related to the device with the identifier. The method further includes activating the tag. Subsequent to activating the tag the identifier is received from the tag at a reader and the reader receives the information related to the device and displays the related information.

One or more embodiments of the invention provide a system for identifying a device and information related to the device. The system includes multiple tags respectively connected to multiple devices. Each of the tags includes a transceiver, a memory, an Integrated Circuit (IC) chip configured to read the memory and transmit data via the transceiver, and a battery in electrical communication with the transceiver and configured to selectively power the memory, the IC chip and the transceiver only upon activation of the tag. The system also includes a mobile reader having a display and a reader transceiver. The mobile reader is configured to receive the transmitted data from the transceiver subsequent to a tag being activated and display the data on the display.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a line drawing of a top view of a tag in accordance with one or more embodiments of the invention;

FIG. 2 is a line drawing illustrating an exploded top view of the tag according to FIG. 1;

FIG. 3 is a line drawing illustrating a left side view of the tag according to FIG. 1;

FIG. 4 is a line drawing illustrating a front view of the tag according to FIG. 1;

FIG. 5 is a line drawing illustrating an exploded front view of the tag according to FIG. 1;

FIG. 6 is a line drawing illustrating a bottom view of the tag according to FIG. 1;

FIG. 7 is a line drawing illustrating an exploded bottom view of the tag according to FIG. 1;

FIG. 8 is a line drawing illustrating a top view of a tag in accordance with one or more alternate embodiments of the invention;

FIG. 9 is a line drawing illustrating an exploded top view of the tag according to FIG. 8;

FIG. 10 is a line drawing illustrating a left side view of the tag according to FIG. 8;

FIG. 11 is a line drawing illustrating a front view of the tag according to FIG. 8;

FIG. 12 is a line drawing illustrating an exploded front view of the tag according to FIG. 8;

FIG. 13 is a line drawing illustrating a bottom view of the tag according to FIG. 8;

FIG. 14 is a line drawing illustrating an exploded bottom view of the tag according to FIG. 8;

FIG. 15 is a line drawing illustrating a top view of a flattened cuff in accordance with one or more embodiments of the invention;

FIG. 16 is a line drawing illustrating a rear view of the flattened cuff according to FIG. 15;

FIG. 17 is a line drawing illustrating a left side view of the flattened cuff according to FIG. 15;

FIG. 18 is a line drawing illustrating a front view of the flattened cuff according to FIG. 15; and,

FIG. 19 is a line drawing illustrating a bottom view of the flattened cuff according to FIG. 15;

### DETAILED DESCRIPTION OF THE INVENTION

While the making and using of various embodiments of the present invention are discussed in detail below, it should be appreciated that the invention provides many applicable inventive concepts that may be embodied in a wide variety of specific contexts. The specific embodiments discussed herein are merely illustrative of specific ways to make and use the invention and do not delimit the scope of the invention.

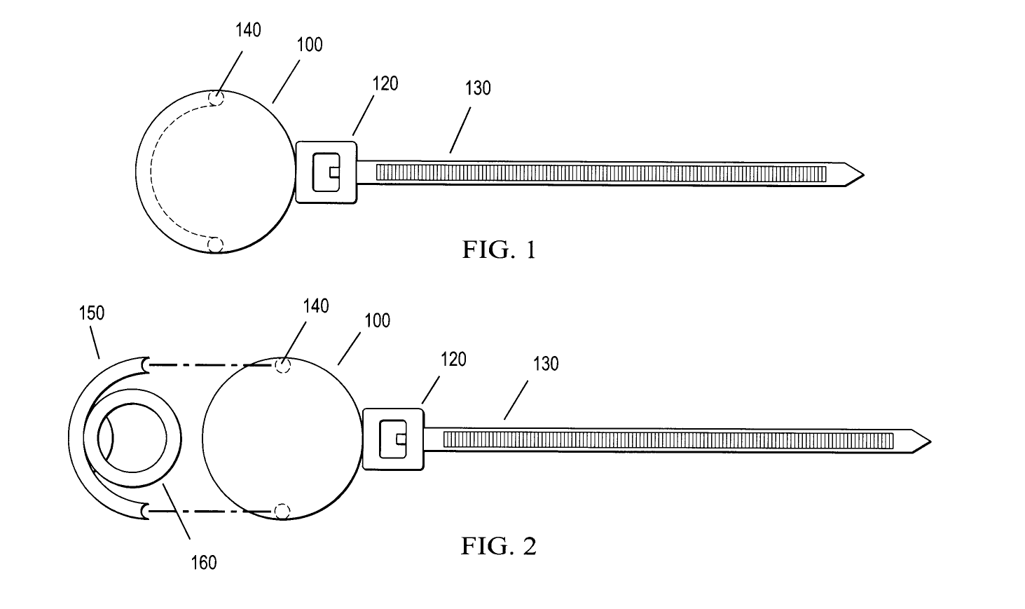

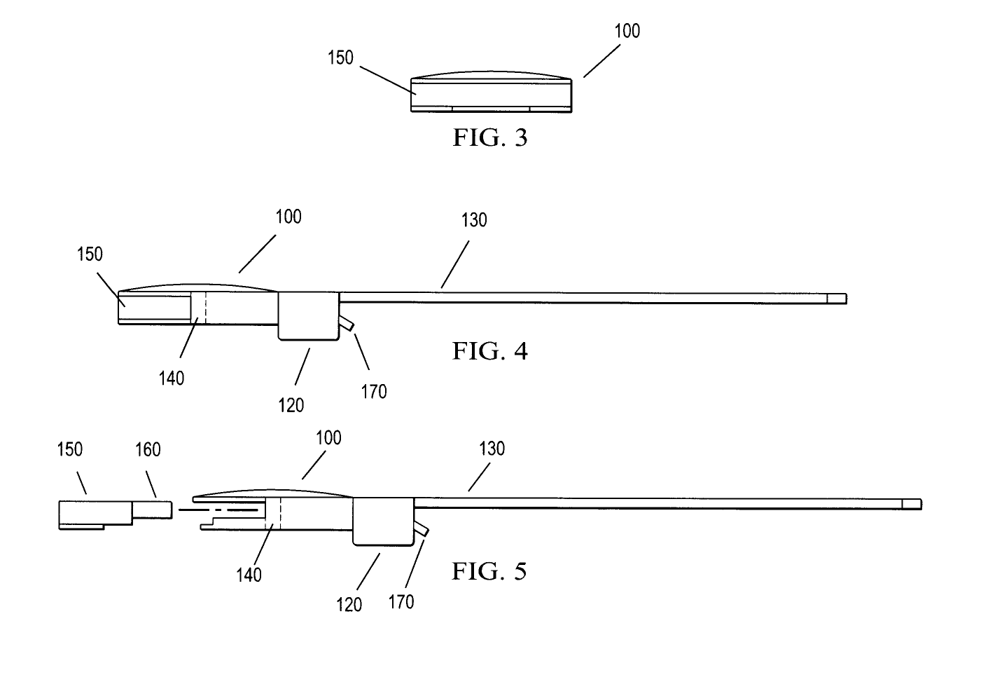

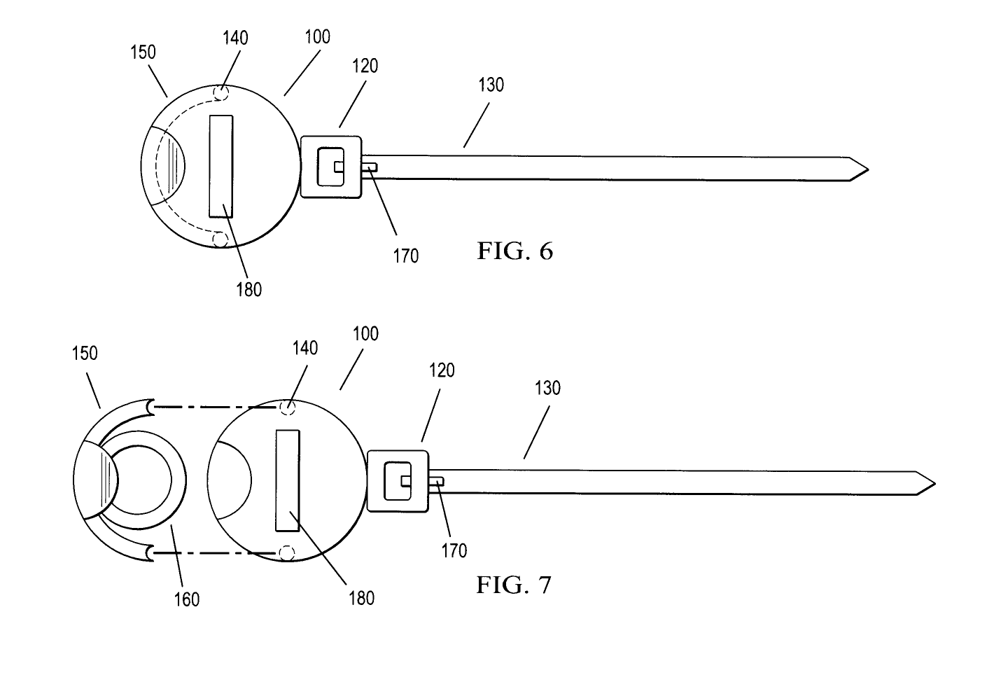

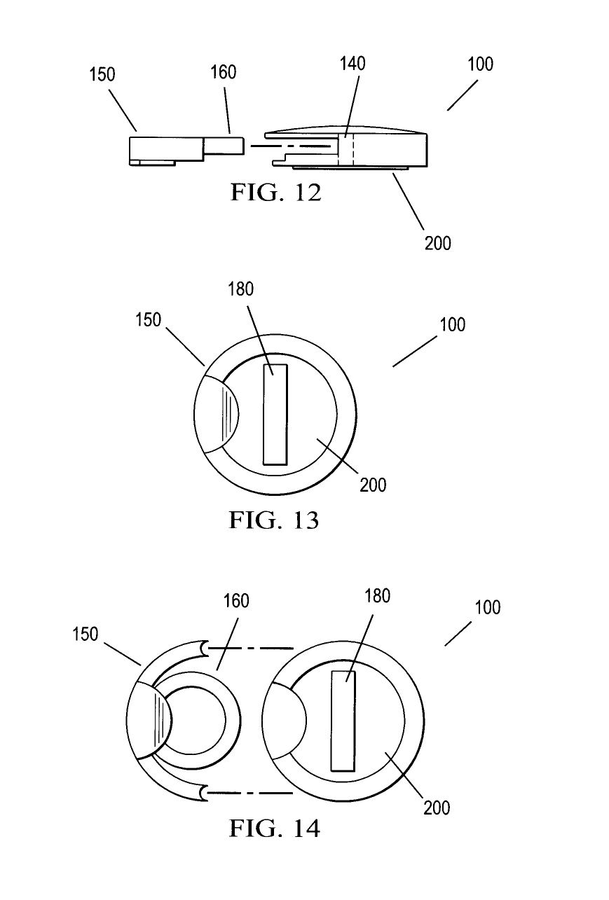

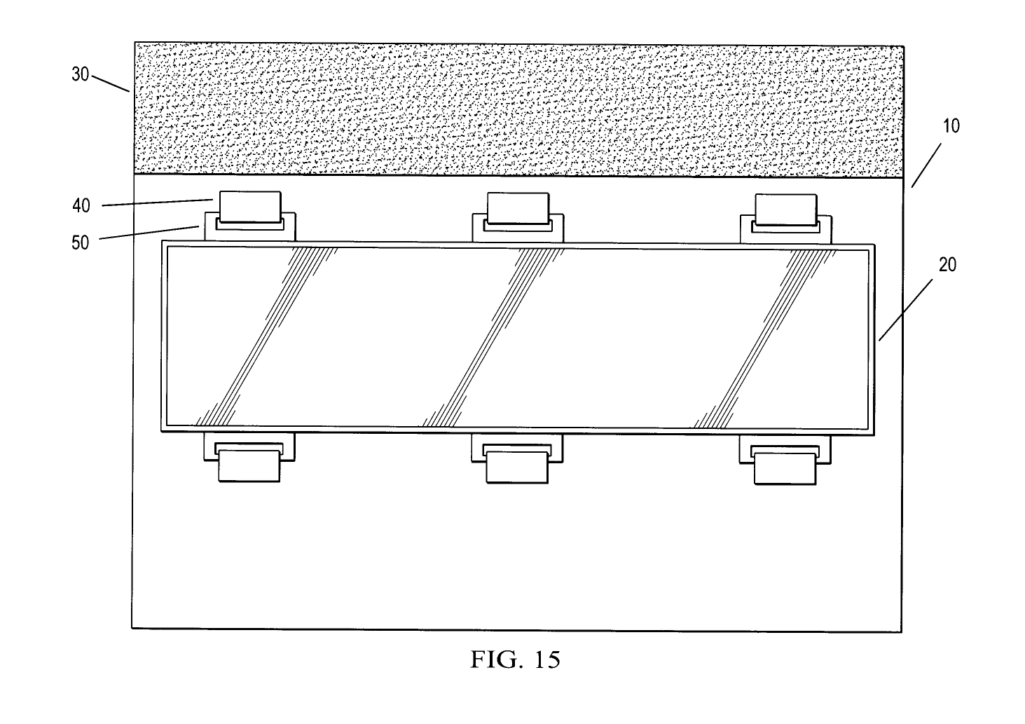

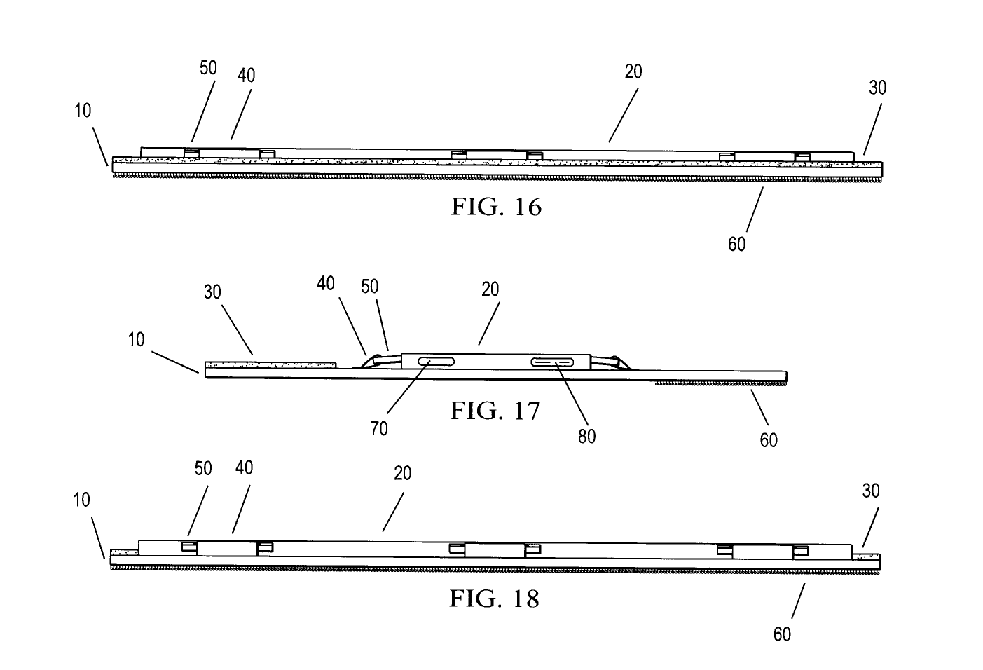

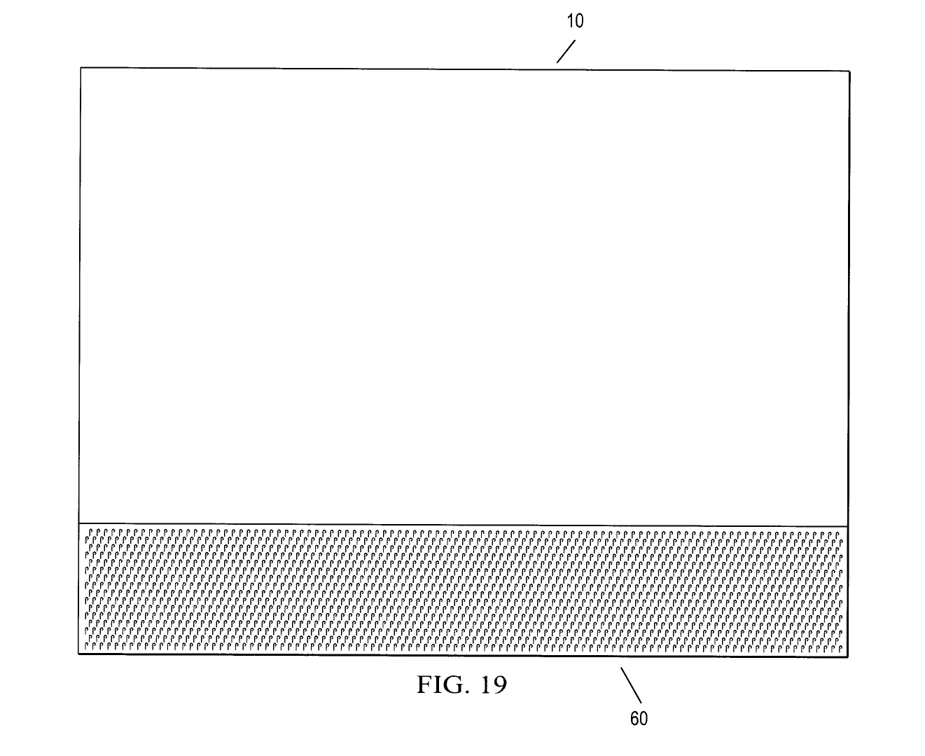

One or more embodiments of the invention includes an adjustable armband 10 illustrated in FIGS. 15-19 and various forms of activation. In the embodiment illustrated in FIGS. 15-19, the armband 10 has a display 20, a Radio Frequency (RF) transceiver (not illustrated), and a Wi-Fi (ISO 802.11) connection (not illustrated) to a computing system hosting a database (in this embodiment, the computing system is a custom server application that includes a database, an interface for communicating with any readers, an interface to third-party application programming interfaces (APIs), and a graphical user interface for administrative tasks, such as adding tags to the system)(not illustrated). As illustrated in FIGS. 15-19 the armband 10 may include a cuff 10 made from flexible cloth with a hook section 60 and a loop section 30 for adjustably securing the armband 10. The display 20 may be a multi-line touchscreen display 20 which is attached to the cuff 10 via elastic 40 and brackets 50. The activation component in this embodiment is a “tag” 100 (such as the one illustrated in FIG. 1-7 or 8-14), which contains the components listed below, but only transmits its identification number 180 (which may also be provided on the tag 100 for visual confirmation) when it is requested by a user (which is advantageous for power efficiency). Each time a tag 100 is activated, an armband 10 reads the unique identifier 180 and the information stored in the database is presented to the user on the armband's display 20. This allows a datacenter administrator to identify and update information for cables, servers, networking devices, storage devices and/or other components.

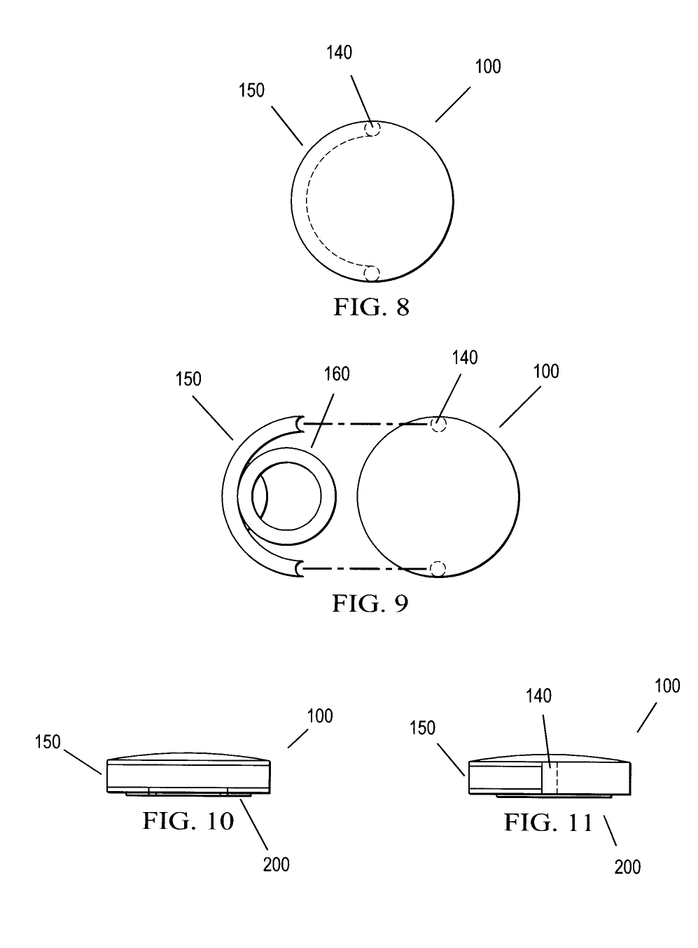

One or more embodiments of the invention includes a specialized armband 10 and tags 100 that also integrate with popular Data Center Infrastructure Management (DCIM) applications in order to improve universal adoption. As illustrated in FIGS. 1-14, the tag 100 may include light emitting diodes (LEDs) 140, a removable battery holder 160 and a light refracting window 150 to allow the light from the LEDs 140 to emanate from the tag 100. As illustrated in FIGS. 1-7, the tag 100 may include a cable tie portion 130 attached to the tag 100 for attaching the tag 100 to a device. The cable tie 130 may be adjustably secured by a cable tie release 170. In an alternate embodiment illustrated in FIGS. 8-14, the tag 100 may include a magnet 200 for selectively attaching the tag 100 to a device.

The Tag 100 in this embodiment includes the following characteristics: an RF transceiver; a memory component; an Integrated Circuit (IC) chip that reads the memory component and transmits data via the RF transceiver; a replaceable battery which powers the components when the tag 100 is activated; an optical device such as a Light Emitting Diode (LED) 140 that will light up for a short period of time after the tag 100 is powered; an audible device such as a piezo-electric device to generate an audible signal; the tag's unique identifier 180 printed on the device.

Features of the invention include: a wired and/or wireless network adapter; as mentioned before, an RF transceiver/repeater (the RF repeater is used to identify tags in physical space by forwarding requests in global mode); a USB port; a Power supply; a User interface to configure settings; and an Armband 10 that bridges communication between the tags 100 and custom server applications and displays information useful to a data center technician.

A Mobile Application embodiment (not illustrated) is an alternative to the previously described armband 10. The Mobile Application operates on a mobile device, such as an iPhone, Android device, or a Microsoft Surface Pro. Exemplary features include: an intuitive graphical user interface that allows a technician to utilize a Digital Label Management System (DLMS); bridges communication between tags 100 and the custom server application. The mobile device, as well as Custom Server Application, translates a tag's unique identifier 180 into information useful to a data center technician.

The term “reader” 10 is intended to be an armband or mobile application similar to what was mentioned previously.

A lookup process is defined as follows. The reader 10 receives a unique identifier 180 from a tag 100. It then transmits the unique identifier 180 via Wi-Fi to a centralized system hosting a database. Using the database, the system translates the unique identifier into a human understandable description. This description is then transmitted back to the reader 10 and presented on the display 20.

In one or more embodiment the user may wish to know what equipment is connected to a specific cable. In this scenario, the user squeezes the tag 100; this results in the tag 100 activating its optical 140 and/or audible device and sending its unique identifier 180 (represented as a numeric or otherwise unique identifier) via RF signal to the receiving reader 10. The reader 10 then proceeds with the lookup process.

Another scenario may include a user wishing to see all of the cables associated with a particular device, service, or virtual machine (VM), referred to as elements. The user searches for the desired element using the reader's user interface 20, selects it from the list of options, and requests that all tags 100_associated with it activate their optical 140 and/or audible device for a specified period of time. When the request is made, the reader 10 requests the unique identifiers 180 of all the tags 100 associated with the device from the database via Wi-Fi. Then the reader 10 notifies those tags 100 to activate their respective optical 140 and/or audible device(s).

Yet another alternative could be to identify circuits in a breaker box. For this embodiment, a tag 100 with a magnet 200 could be used on the back of the circuit box. This would improve the current methods many people use including paper labels, stickers, or tape with only minimal space for identifying information. It is possible to even integrate DLMS into the breaker box panel itself. However implemented, using DLMS in the breaker box could be used to identify the exact items on the circuit. Rather than the generic descriptions currently used, such as “kitchen outlets 1” or “living room wall 3”, the DLMS could display descriptions such as “kitchen outlets supporting refrigerator and microwave” or “living room wall with entertainment system and lamp next to the door”.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. For example, the tags 100 can be programmed to be constantly active, or in intervals to preserve battery resources. In addition, the RF repeaters, or other such similar devices, can be programmed to activate on intervals as well, or to be constantly active. It is therefore intended that the appended claims accomplish any such modifications or embodiments.

1. (canceled)

2. A method for identifying a device and information related to the device, the method comprising:
associating a tag with the device; wherein the tag includes a identifier;
maintaining said tag in a dormant state;
associating information related to the device with the identifier;
activating the tag;
subsequent to activating said tag, receiving said identifier from said tag at a reader and receiving said information related to the device at said reader; and,
displaying said related information.

3. The method according to claim 2 further comprising: said reader forwarding said identifier for receipt by a remote location.

4. The method according to claim 3 wherein said remote location displays said related information.

5. The method according to claim 3 further comprising said reader receiving said related information from said remote location.

6. The method according to claim 2 further comprising said reader receiving said related information from said tag.

7. The method according to claim 2 further comprising said tag generating an audible signal upon activation.

8. The method according to claim 2 further comprising said tag generating a visual signal upon activation.

9. The method according to claim 2 wherein said activating said tag includes pressing a button on the tag.

10. The method according to claim 2 wherein said activating said tag includes transmitting an activation signal to said tag.

11. The method according to claim 2 wherein said associating the tag with the device comprises attaching the tag to the device.

12. The method according to claim 9 wherein said attaching is a magnetic attachment.

13. The method according to claim 9 wherein said attaching is accomplished via a tie.

14. A system for identifying a device and information related to the device, the system comprising:
a plurality of tags coupled to a plurality of devices, each of said plurality of tags including a transceiver; a memory; an Integrated Circuit (IC) chip configured to read the memory and transmit data via the transceiver; and a battery electrically coupled to the transceiver and configured to selectively power the memory, the IC chip and the transceiver only upon activation of the tag; and,
a mobile reader having a display and a reader transceiver, said mobile reader being configured to receive said transmitted data with said reader transceiver subsequent to a tag being activated and display said data on said display.

15. The system according to claim 14 wherein at least one of said plurality of tags includes an optical device which illuminates upon said activation.

16. The system according to claim 15 wherein said optical device is a Light Emitting Diode (LED).

17. The system according to claim 14 wherein at least one of said plurality of tags includes an audio device which generates an audible sound upon said activation.

18. The system according to claim 17 wherein said audio device is a piezo-electric device.

19. The system according to claim 14 wherein said transceiver is a radio frequency (RF) transceiver.

20. The system according to claim 14 further comprising a remote server and said mobile reader further comprising a plurality of reader transceivers; wherein said mobile reader is configured to transmit via at least one of said plurality of reader transceivers said transmitted data to said remote server.

21. The system according to claim 20 wherein said remote server includes a server transceiver and a database and wherein said database is configured to translate said transmitted data and return said transmitted data to said mobile reader via said server transceiver.
